(19) United States
(12) Patent Application Publication
(10) Pub. No.: US 2012/0212517 A1
(43) Pub. Date: Aug. 23, 2012

(54) ORGANIC LIGHT-EMITTING DISPLAY AND METHOD OF DRIVING THE SAME

(76) Inventor: Jeong-Keun Ahn, Yongin-city (KR)

(21) Appl. No.: 13/239,314

(22) Filed: Sep. 21, 2011

(30) Foreign Application Priority Data
Feb. 17, 2011 (KR) 10-2011-0014182

(51) Int. Cl. G09G 5/10

(52) U.S. Cl. 345/690; 345/77

(57) ABSTRACT

An organic light-emitting display includes a scan driver for transmitting scan signals to scan lines, a data driver for transmitting data signals to data lines, an emission driver for transmitting light emission control signals to light emission control lines, and a display unit including a plurality of pixels coupled to the scan lines, the data lines, and the light emission control lines. The emission driver includes a plurality of stages, and each of the stages includes a transistor having a first electrode coupled to a first power source, a second electrode coupled to one of the light emission control lines, and a gate electrode coupled to an input terminal to which a block control signal is input.

### CROSS-REFERENCE TO RELATED APPLICATION

This application claims priority to and the benefit of Korean Patent Application No. 10-2011-0014182, filed on Feb. 17, 2011, in the Korean Intellectual Property Office, the disclosure of which is incorporated herein by reference in its entirety.

### BACKGROUND

1. Field

Aspects of embodiments according to the present invention relate to an organic light-emitting display and a method of driving the same.

2. Description of the Related Art

Various flat panel displays have recently been developed as alternatives to relatively heavy and bulky cathode ray tube (CRT) displays. Examples of flat panel displays include liquid crystal displays (LCDs), field emission displays (FEDs), plasma display panels (PDPs), and organic light-emitting displays.

Among the flat panel displays, the organic light-emitting displays display an image using organic light-emitting diodes (OLEDs) that can emit light by electron-hole recombination. Such organic light-emitting displays have fast response time and low power consumption. Generally, an organic light-emitting display employs a transistor provided in each pixel to supply a current corresponding to a data signal to an OLED, thereby allowing the OLED to emit light.

A conventional organic light-emitting display includes a data driver for transmitting data signals to data lines, a scan driver for sequentially transmitting scan signals to scan lines, an emission driver for transmitting light emission control signals to light emission control lines, and a display unit including a plurality of pixels coupled to the data lines, the scan lines, and the light emission control lines.

Each of the pixels included in the display unit is selected when a scan signal is transmitted to a scan line, and thus receives a data signal from a data line. Each pixel receiving the data signal emits light with a corresponding luminance (e.g., a predetermined luminance), thereby displaying an image. Here, the light emission time of each pixel is controlled by a light emission control signal transmitted from a light emission control line.

The amount of current flowing through the display unit increases as an image to be displayed has a higher gray level that is close to white. The increased amount of current flowing through the display unit increases the influence of IR drop that occurs in power wiring.

### SUMMARY

Aspects of embodiments according to the present invention are directed toward an organic light-emitting display in which the amount of current flowing through a display unit can be limited to prevent or reduce the IR drop of power wiring.

Aspects of embodiments according to the present invention also are directed toward a method of driving an organic light-emitting display in which the amount of current flowing through a display unit can be limited to prevent or reduce the IR drop of power wiring.

However, aspects of the present invention are not restricted to the embodiments set forth herein. The above and other aspects of the present invention will become more apparent to one of ordinary skill in the art to which the present invention pertains by referencing the detailed description of the embodiments according to the present invention given below.

According to an embodiment of the present invention, there is provided an organic light-emitting display including a scan driver for transmitting scan signals to scan lines, a data driver for transmitting data signals to data lines, an emission driver for transmitting light emission control signals to light emission control lines, and a display unit including a plurality of pixels coupled to the scan lines, the data lines, and the light emission control lines. Here, the emission driver includes a plurality of stages, and each of the stages includes a transistor having a first electrode coupled to a first power source, a second electrode coupled to one of the light emission control lines, and a gate electrode coupled to an input terminal to which a block control signal is input.

According to another embodiment of the present invention, there is provided a method of driving an organic light-emitting display. The method includes transmitting a light emission control signal to a display unit from an emission driver which includes a plurality of stages coupled respectively to a plurality of light emission control lines. When a voltage of a first power source is output from some of the light emission control lines, a block control signal is transmitted to corresponding ones of the stages coupled to the other ones of the light emission control lines so as to output a voltage of a second power source from the other ones of the light emission control lines.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of an organic light-emitting display according to a first exemplary embodiment of the present invention;

FIG. 2 is a schematic diagram of an emission driver of FIG. 1 according to the first exemplary embodiment of the present invention;

FIG. 3 is a schematic diagram illustrating an internal circuit of each stage;

FIG. 4 is a waveform diagram of input and output signals of the emission driver included in the organic light-emitting display according to the first exemplary embodiment of the present invention;

FIG. 5 is a block diagram of an organic light-emitting display according to a second exemplary embodiment of the present invention;

FIG. 6 is a block diagram of an organic light-emitting display according to a third exemplary embodiment of the present invention;

FIG. 7 is a schematic diagram of a scan driver shown in FIG. 6;

FIG. 8 is a schematic diagram of an emission driver shown in FIG. 6;

FIG. 9 is a waveform diagram of input and output signals of the emission driver included in the organic light-emitting display according to the second exemplary embodiment of the present invention;

FIG. 10 is a block diagram of an organic light-emitting display according to a fourth exemplary embodiment of the present invention; and

FIG. 11 is a schematic diagram of an emission driver of FIG. 10 according to the fourth exemplary embodiment of the present invention.

### DETAILED DESCRIPTION

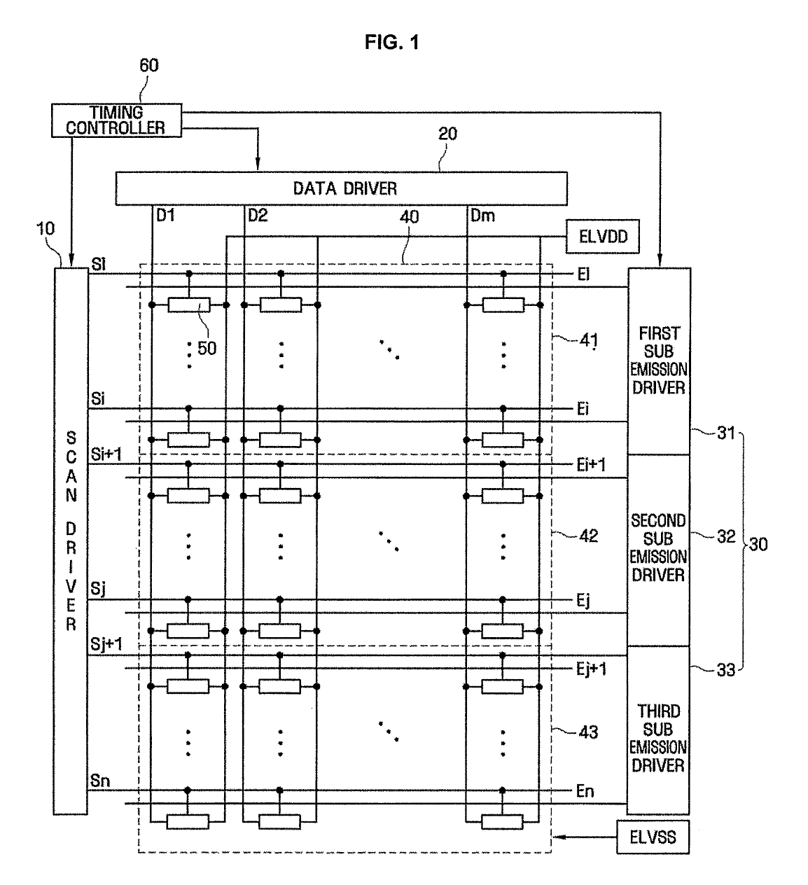

An organic light-emitting display and a method of driving the same according to a first exemplary embodiment of the present invention will be described with reference to FIGS. 1 through 4.

FIG. 1 is a block diagram of an organic light-emitting display according to a first exemplary embodiment of the present invention. In FIG. 1, a scan driver 10 and an emission driver 30 are separated from each other. However, the emission driver 30 may also be included in the scan driver 10.

Referring to FIG. 1, the organic light-emitting display according to the first exemplary embodiment includes a display unit 40 including a plurality of pixels 50 which are coupled to a plurality of scan lines S1 through Sn, a plurality of data lines D1 through Dm and a plurality of light emission control lines E1 through En, the scan driver 10 for driving the scan lines S1 through Sn, a data driver 20 for driving the data lines D1 through Dm, the emission driver 30 for driving the light emission control lines E1 through En, and a timing controller 60 for controlling the scan driver 10, the data driver 20, and the emission driver 30. The scan lines S1 through Sn may cross the data lines D1 through Dm, and the light emission control lines E1 through En may be parallel to the scan lines S1 through Sn.

Controlled by the timing controller 60, the scan driver 10 sequentially transmits scan signals to the scan lines S1 through Sn. Accordingly, the pixels 50 coupled to the scan lines S1 through Sn are selected sequentially.

The data driver 20 is controlled by the timing controller 60 to transmit data signals to the data lines D1 through Dm. Here, the data driver 20 transmits the data signals to the data lines D1 through Dm whenever a scan signal is transmitted. Accordingly, the data signals are transmitted to the pixels 50 selected by the scan signal, and the pixels 50 are charged with voltages corresponding to the received data signals, respectively.

The emission driver 30 is controlled by the timing controller 60 to transmit light emission control signals to the light emission control lines E1 through En. For example, the emission driver 30 may control the light emission of the pixels 50 by transmitting the light emission control signals at a low level or a high level. The emission driver 30 includes a plurality of sub emission drivers. For example, the emission driver 30 may include first through third sub emission drivers 31 through 33. In FIG. 1, the emission driver 30 includes three sub emission drivers 31 through 33. However, the present invention is not limited thereto, and the emission driver 30 may also include two, four, or more sub emission drivers. The first through third sub emission drivers 31 through 33 are driven separately.

The display unit 40 includes a plurality of pixels 50 arranged in a matrix. Each of the pixels 50 generates light with a luminance (e.g., a predetermined luminance) in accordance with a current corresponding to a data signal from a first power source ELVDD to a second power source ELVSS via an organic light-emitting diode (not shown). The display unit 40 includes a plurality of pixel blocks, e.g., first through third pixel blocks 41 through 43 which correspond respectively to the first through third sub emission drivers 31 through 33 and are driven separately by the first through third sub emission drivers 31 through 33. In FIG. 1, the display unit 40 includes three pixel blocks, that is, the first through third pixel blocks 41 through 43. However, the present invention is not limited thereto, and the display unit 40 may also include two, four, or more pixel blocks. Each of the first through third pixel blocks 41 through 43 may include the pixels 50 coupled to a plurality of successive light emission control lines E1 through Ei, Ei+1 through Ej, or Ej+1 through En.

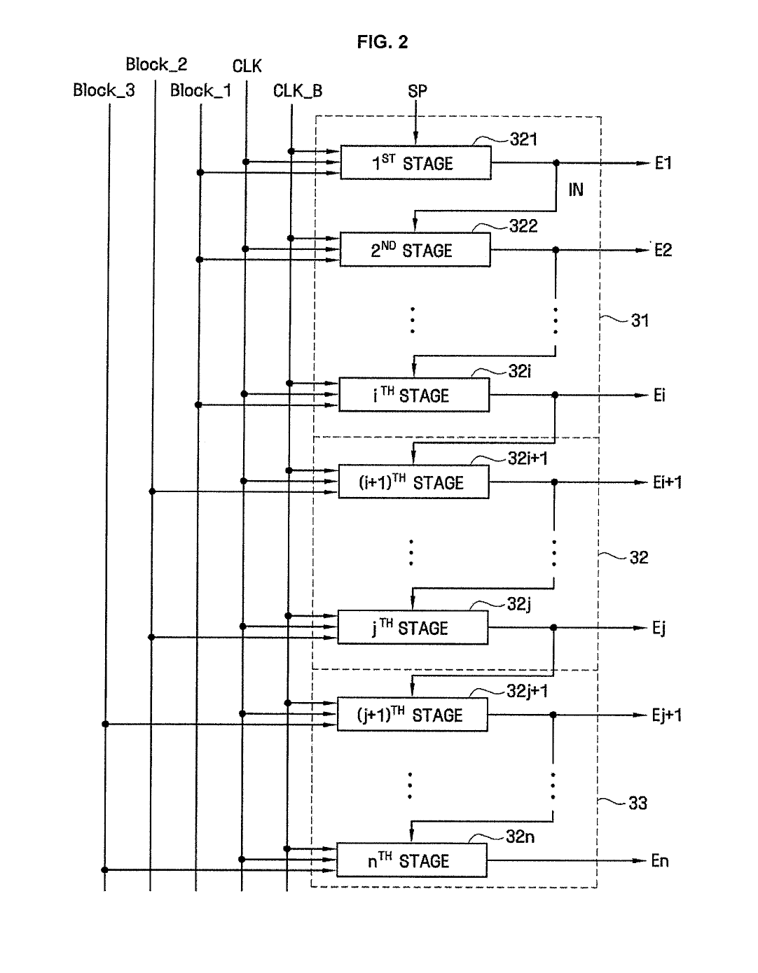

FIG. 2 is a schematic diagram of the emission driver 30 of FIG. 1 according to the first exemplary embodiment of the present invention.

Referring to FIG. 2, the emission driver 30 according to the first exemplary embodiment includes first through n^{th} stages 321 through 32n that are coupled to the light emission control lines E1 through En, respectively.

The timing controller 60 (see FIG. 1) transmits two clock signals CLK and CLK_B, a start signal SP, and three block control signals, e.g., first through third block control signals Block_1 through Block_3, to the emission driver 30. The two clock signals CLK and CLK_B are inverted signals of each other. The start signal SP is transmitted to the first stage 321. An output of the i^{th} stage 32i (where i is a natural number) is transmitted to the (i+1)^{th} stage (32i+1). The first block control signal Block_1 is transmitted to the first sub emission driver 31, the second block control signal Block_2 is transmitted to the second sub emission driver 32, and the third block control signal Block_3 is transmitted to the third sub emission driver 33.

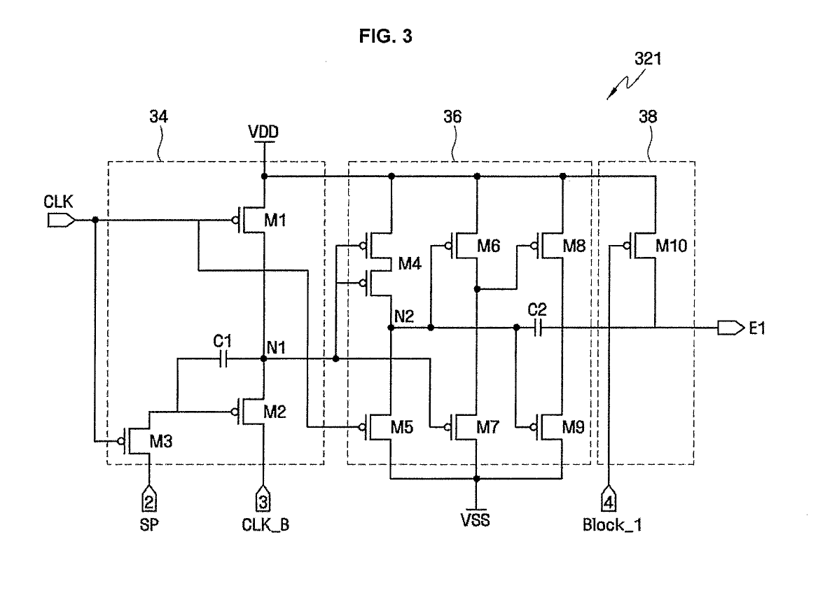

FIG. 3 is a schematic diagram illustrating an internal circuit of each stage. In FIG. 3, the first stage 321 coupled to the two clock signals CLK and CLK_B, the start signal SP, and the first block control signal Block_1, is illustrated for ease of description.

Referring to FIG. 3, the first stage 321 includes an input unit 34 which transmits any one of a first signal and a second signal in response to the clock signals CLK and CLK_B and the start signal SP, an output unit 36 which controls the generation of a light emission control signal in response to the first or second signal received from the input unit 34, and a control unit 38 which controls the light emission control signal to be transmitted while the second and third pixel blocks 42 and 43 are driven.

The input unit 34 includes a first transistor M1 coupled to a third power source VDD (or ELVDD) and a first input terminal, a third transistor M3 coupled to the first input terminal and a second input terminal, a second transistor M2 coupled to the third transistor M3 and a third input terminal, and a first capacitor C1 coupled between a gate electrode and a first electrode (e.g., a source electrode) of the second transistor M2.

A first electrode of the first transistor M1 is coupled to the third power source VDD, and a gate electrode thereof is coupled to the first input terminal. In addition, a second electrode (e.g., a drain electrode) of the first transistor M1 is coupled to a first node N1. The first transistor M1 is turned on when the clock signal CLK at a low level is transmitted to the first input terminal and applies a voltage of the third power source VDD to the first node N1.

The first electrode of the second transistor M2 is coupled to the first node N1, and a second electrode thereof is coupled to the third input terminal. In addition, the gate electrode of the second transistor M2 is coupled to a first electrode of the third transistor M3. The second transistor M2 is turned on or off in accordance with a voltage charged in the first capacitor C1. Here, the third input terminal receives the inverted clock signal CLK_B.

The first electrode of the third transistor M3 is coupled to the gate electrode of the second transistor M2, and a second electrode thereof is coupled to the second input terminal. In addition, a gate electrode of the third transistor M3 is coupled to the first input terminal. The third transistor M3 is turned on when the clock signal CLK at a low level is transmitted to the first input terminal. Here, the start signal SP or a light emission control signal of a previous stage is transmitted to the second input terminal.

The first capacitor C1 is coupled between the gate electrode and the first electrode of the second transistor M2. When the third transistor M3 is turned on and when the start signal SP is transmitted to the second input terminal, the first capacitor C1 is charged to a voltage that is sufficient to turn the second transistor M2 on. In other cases, the first capacitor C1 is not charged.

The output unit 36 outputs a light emission control signal (e.g., a high level signal) when the second signal (e.g., a low level signal) is transmitted to the first node N1. The output unit 36 does not output the light emission control signal when the first signal (e.g., a high level signal) is transmitted to the first node N1.

To perform this function, the output unit 36 includes a fourth transistor M4, a sixth transistor M6, and an eighth transistor M8 coupled to the third power source VDD; a fifth transistor M5, a seventh transistor M7, and a ninth transistor M9 coupled to a fourth power source VSS (or ELVSS); and a second capacitor C2 coupled between a gate electrode and a first electrode of the ninth transistor M9.

A first electrode of the fourth transistor M4 is coupled to the third power source VDD, and a second electrode thereof is coupled to a second node N2. In addition, a gate electrode of the fourth transistor M4 is coupled to the first node N1.

A first electrode of the fifth transistor M5 is coupled to the second node N2, and a second electrode thereof is coupled to the fourth power source VSS. In addition, a gate electrode of the fifth transistor M5 is coupled to the first input terminal.

A first electrode of the sixth transistor M6 is coupled to the third power source VDD, and a second electrode thereof is coupled to a first electrode of the seventh transistor M7. In addition, a gate electrode of the sixth transistor M6 is coupled to the second node N2.

The first electrode of the seventh transistor M7 is coupled to the second electrode of the sixth transistor M6, and a second electrode thereof is coupled to the fourth power source VSS. In addition, a gate electrode of the seventh transistor M7 is coupled to the first node N1.

A first electrode of the eighth transistor M8 is coupled to the third power source VDD, and a second electrode thereof is coupled to the light emission control line E1. In addition, a gate electrode of the eighth transistor M8 is coupled to the second electrode of the sixth transistor M6.

The first electrode of the ninth transistor M9 is coupled to the light emission control line E1, and a second electrode thereof is coupled to the fourth power source VSS. In addition, the gate electrode of the ninth transistor M9 is coupled to the second node N2.

The second capacitor C2 is coupled between the gate electrode and the first electrode of the ninth transistor M9. The second capacitor C2 controls the ninth transistor M9 to be turned on or off.

The control unit 38 controls the transmission of the light emission control signal while the second and third pixel blocks 42 and 43 are driven. The control unit 38 includes a tenth transistor M10.

A first electrode of the tenth transistor M10 is coupled to the third power source VDD, and a second electrode thereof is coupled to the light emission control signal E1. In addition, a gate electrode of the tenth transistor M10 is coupled to a fourth input terminal to which the first block control signal Block_1 is transmitted. The tenth transistor M10 is turned on when receiving the first block control signal Block_1 and is turned off when not receiving the first block control signal Block_1

A method of driving the organic light-emitting display of FIG. 1 may be described as follows.

When data corresponding to one frame is input, the input data is divided into blocks corresponding to the first through third pixel blocks 41 through 43, respectively. Then, data in each of the blocks corresponding respectively to the first through third pixel blocks 41 through 43 are added together for each of the first through third pixel blocks 41 through 43. Next, a value of the added data for each of the first through third pixel blocks 41 through 43 is compared with a reference value. Here, the reference value may be a maximum value among the value of the added data for each of the first through third pixel blocks 41 through 43 when an IR drop does not occur in the power wiring.

It is determined whether all of the values of the added data for the first through third pixel blocks 41 through 43 are equal to or less than the reference value. When all of the values of the added data for the first through third pixel blocks 41 through 43 are equal to or less than the reference value, the organic light-emitting display may be driven using a conventional driving method instead of a pixel block-based driving method. On the other hand, when any one of the values of the added data for the first through third pixel blocks 41 through 43 exceeds the reference value, the organic light-emitting display is driven using a pixel block-based driving method according to the first exemplary embodiment of the present invention, as will be described below.

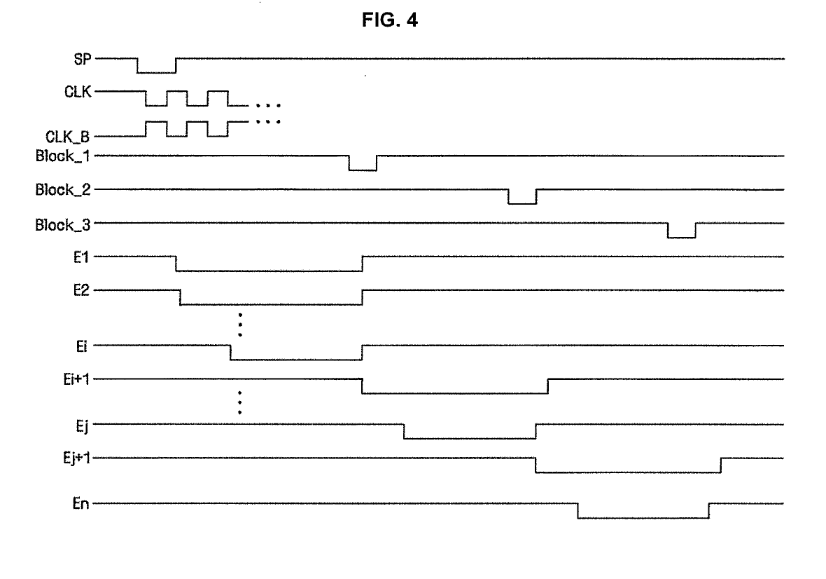

A method of driving the organic light-emitting display of FIG. 1 on a pixel block-by-pixel block basis will now be described with reference to FIGS. 1 through 4. FIG. 4 is a waveform diagram of input and output signals of the emission driver 30 included in the organic light-emitting display according to the first exemplary embodiment of the present invention.

Referring to FIG. 4, when the start signal SP at a low level and the clock signals CLK and CLK_B that are inverted from each other are transmitted to the first stage 321 of the first sub emission driver 31, the first sub emission driver 31 sequentially applies a voltage of the fourth power source VSS to the light emission control lines E1 through Ei during a period of time after data signals are transmitted respectively to the pixels 50 of the first pixel block 41 and before the pixels 50 of the second pixel block 42 are driven. That is, after the data signals are transmitted respectively to the pixels 50 of the first pixel block 41, the pixels 50 of the first pixel block 41 emit light until the pixels 50 of the second pixel block 42 are driven.

During a period of time after all of the pixels 50 of the first pixel block 41 are driven to emit light and before the pixels 50 of the second pixel block 42 emit light, the first block control signal Block_1 set to a low level is transmitted to the tenth transistor M10 of each of the first through i^{th} stages 321 through 32i of the first sub emission driver 31, thereby turning the tenth transistor M10 on. When the tenth transistor M10 is turned on, the voltage of the third power source VDD is applied to the light emission control lines E1 through Ei. That is, when the pixels 50 of the second pixel block 42 are driven to emit light, the pixels 50 of the first pixel block 41 do not emit light. Here, the pixels 50 of the third pixel block 43 also do not emit light. The voltage of the third power source VDD is applied to the light emission control lines E1 through Ei of the first sub emission driver 31 until the start signal SP is transmitted again to the first sub emission driver 31.

An output of the i^{th} stage 32i is transmitted to the (i+1)^{th} stage 321+1, thereby driving the second sub emission driver 32. The second sub emission driver 32 applies the voltage of the fourth power source VSS to the light emission control lines Ei₊1 through Ej during a period of time after data signals are transmitted respectively to the pixels 50 of the second pixel block 42 and before the pixels 50 of the third pixel block 43 are driven. That is, after the data signals are transmitted respectively to the pixels 50 of the second pixel block 42, the pixels 50 of the second pixel block 42 emit light until the pixels 50 of the third pixel block 43 are driven.

During a period of time after all of the pixels 50 of the second pixel block 42 are driven to emit light and before the pixels 50 of the third pixel block 43 emit light, the second block control signal Block_2 set to a low level is transmitted to the tenth transistor M10 of each of the (i+1)^{th} through j^{th} stages 32i+1 through 32j of the second sub emission driver 32, thereby turning the tenth transistor M10 on. When the tenth transistor M10 is turned on, the voltage of the third power source VDD is applied to the light emission control lines Ei+1 through Ej. That is, when the pixels 50 of the third pixel block 43 are driven to emit light, the pixels 50 of the second pixel block 42 do not emit light. Here, the pixels 50 of the first pixel block 41 also continue to not emit light. The voltage of the third power source VDD is applied to the light emission control lines Ei+1 through Ej of the second sub emission driver 32 until the start signal SP is transmitted again.

An output of the j^{th} stage 32j is transmitted to the (j+1)^{th} stage 32j+1, thereby driving the third sub emission driver 33. The third sub emission driver 33 applies the voltage of the fourth power source VSS to the light emission control lines Ej+1 through En during a period of time after data signals are transmitted respectively to the pixels 50 of the third pixel block 43 and before the start signal SP is transmitted again. That is, after the data signals are transmitted respectively to the pixels 50 of the third pixel block 43, the pixels 50 of the third pixel block 43 emit light until the start signal SP of a next frame is transmitted.

During a period of time after all of the pixels 50 of the third pixel block 43 are driven to emit light and before the start signal SP is transmitted again to the first stage 321 of the first sub emission driver 31 so that the pixels 50 of the first pixel block 41 emit light again, the third block control signal Block_3 set to a low level is transmitted to the tenth transistor M10 of each of the (j+1)^{th} through n^{th} stages 32j+1 through 32n of the third sub emission driver 33, thereby turning the tenth transistor M10 on. When the tenth transistor M10 is turned on, the voltage of the third power source VDD is applied to the light emission control lines Ej+1 through En. That is, when the pixels 50 of the first pixel block 41 are driven to emit light by the start signal SP that is transmitted again to the first stage 321 of the first sub emission driver 31, the pixels 50 of the third pixel block 43 do not emit light.

As described above, in the first embodiment of the present invention, the pixels 50 are driven on a pixel block-by-pixel block basis during one frame. That is, when the pixels 50 are divided into the three pixel blocks 41 through 43 as shown in FIG. 1, the first through third pixel blocks 41 through 43 are driven sequentially. In this case, when any one of the first through third pixel blocks 41 through 43 is driven to emit light, the other pixel blocks are not driven and thus do not emit light. As a result, the amount of current flowing through the pixels 50 concurrently (e.g., simultaneously) is limited, thereby reducing or minimizing the IR drop. The reduction or minimization of the IR drop can prevent the deterioration of display quality.

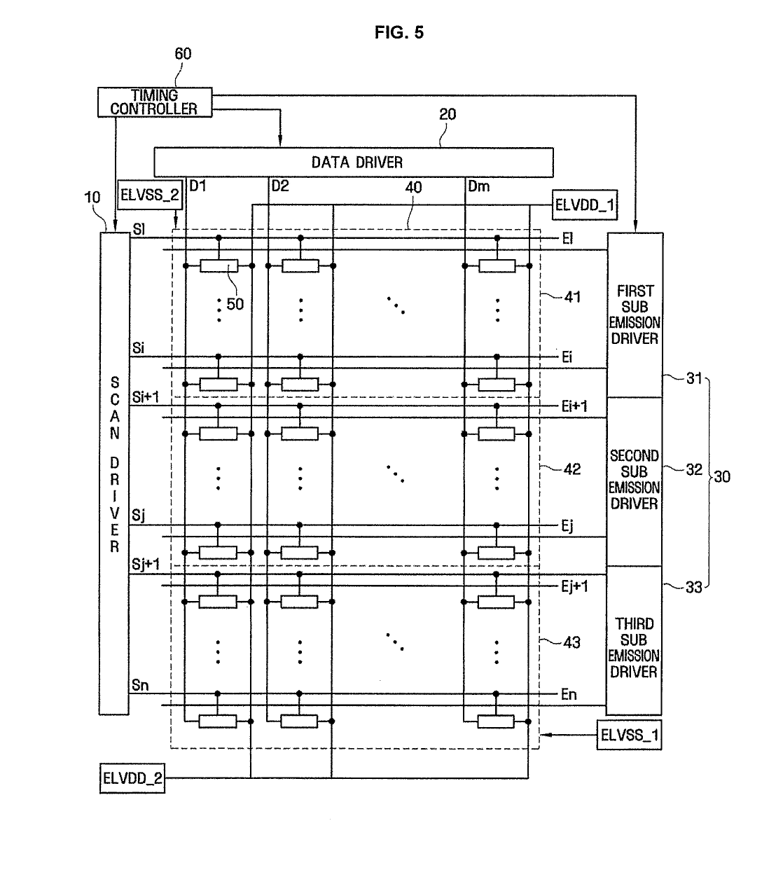

An organic light-emitting display and a method of driving the same according to a second exemplary embodiment of the present invention will be described with reference to FIGS. 1 through 5. FIG. 5 is a block diagram of an organic light-emitting display according to the second exemplary embodiment of the present invention. Elements substantially identical to those of FIG. 1 are indicated by like reference numerals, and thus their detailed description will be omitted.

Referring to FIG. 5, in the organic light-emitting display according to the second exemplary embodiment, a first power source ELVDD, which supplies a current corresponding to a data signal to an organic light-emitting diode (not shown) of each pixel 50, includes a plurality of sub power sources. For example, the first power source ELVDD may include a first sub power source ELVDD_1 and a second sub power source ELVDD_2, as shown in FIG. 5. However, the present invention is not limited thereto, and the first power source ELVDD may include three or more sub power sources. The first sub power source ELVDD_1 and the second sub power source ELVDD_2 may be respectively positioned on both sides of a display unit 40 to face each other.

The organic light-emitting display according to the second exemplary embodiment may be driven using the same method as that (described above with reference to FIGS. 1 through 4) for the organic light-emitting display according to the first exemplary embodiment. Each of first through third pixel blocks 41 through 43 may be supplied with power from an adjacent sub power source. For example, the first pixel block 41 may be supplied with power from the first sub power source ELVDD_1, and the third pixel block 43 may be supplied with power from the second sub power source ELVDD_2. In addition, a region of the second pixel block 42 which is adjacent to the first pixel block 41 may be supplied with power from the first sub power source ELVDD_1, and a region of the second pixel block 42 which is adjacent to the third pixel block 43 may be supplied with power from the second sub power source ELVDD_2.

In the second exemplary embodiment, since each of the first through third pixel blocks 41 through 43 is supplied with power from an adjacent or nearby sub power source, the IR drop that occurs in the power wiring can further be reduced.

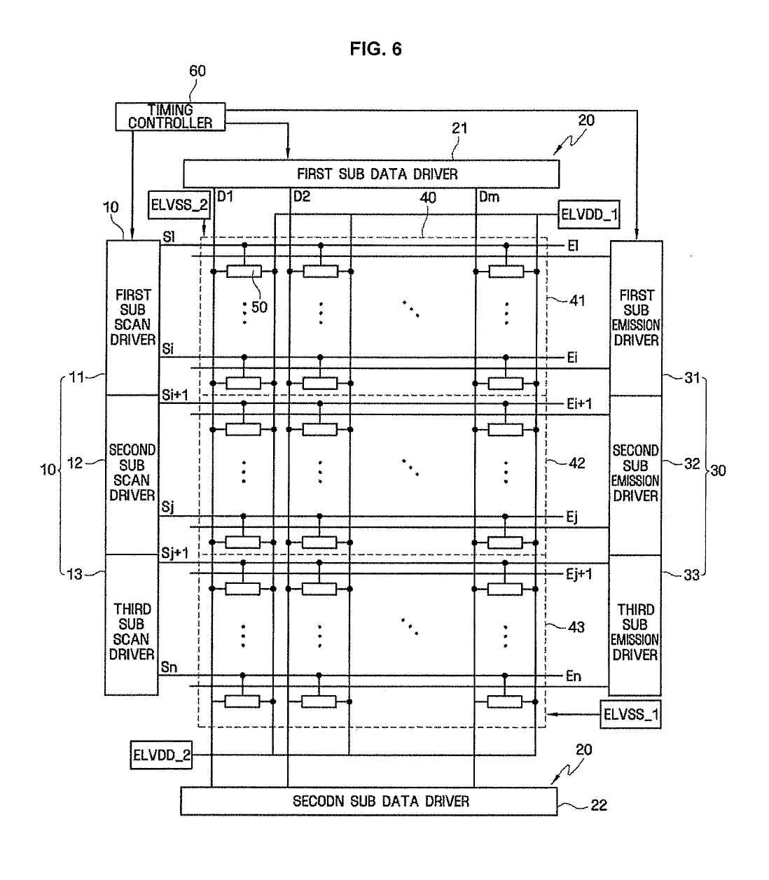

An organic light-emitting display and a method of driving the same according to a third exemplary embodiment of the present invention will be described with reference to FIGS. 6 through 9.

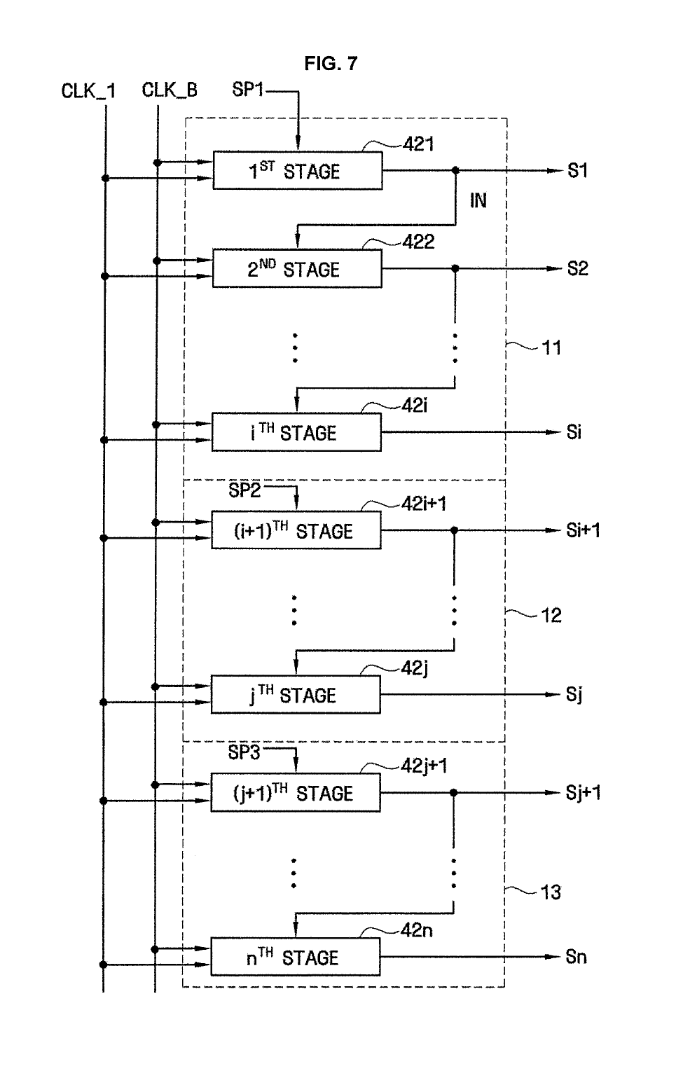

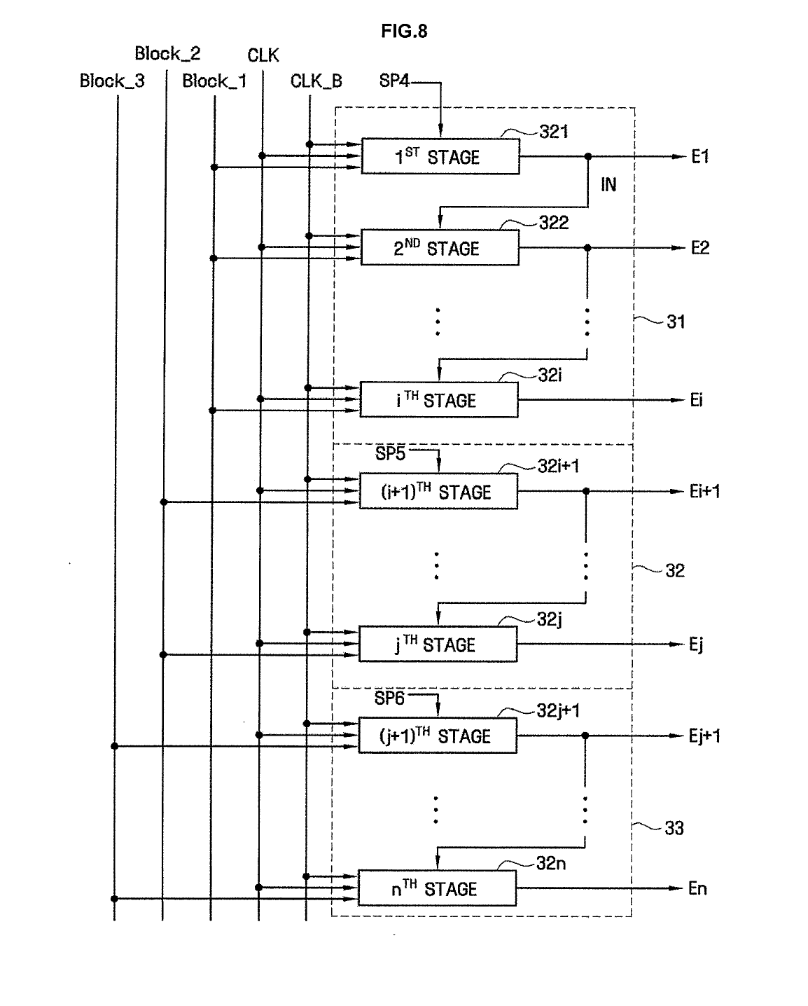

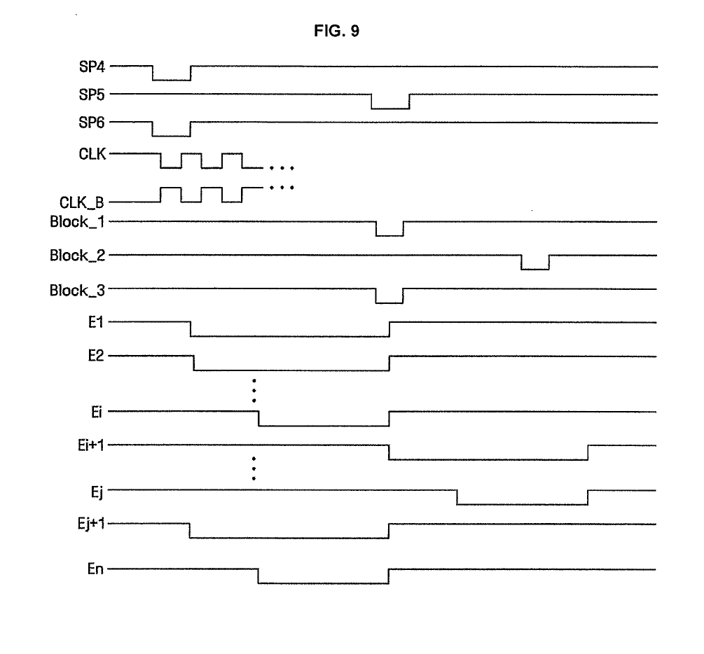

FIG. 6 is a block diagram of an organic light-emitting display according to the third exemplary embodiment of the present invention. FIG. 7 is a schematic diagram of a scan driver 10 shown in FIG. 6. FIG. 8 is a schematic diagram of an emission driver 30 shown in FIG. 6. FIG. 9 is a waveform diagram of input and output signals of the emission driver 30 included in the organic light-emitting display according to the third exemplary embodiment of the present invention. Elements substantially identical to those of FIGS. 1 through 5 are indicated by like reference numerals, and thus their detailed description will be omitted.

Referring to FIG. 6, as in the organic light-emitting display according to the second exemplary embodiment, in the organic light-emitting display according to the third exemplary embodiment, a first power source ELVDD which supplies a current corresponding to a data signal to an organic light-emitting diode (not shown) of each pixel 50 may include a first sub power source ELVDD_1 and a second sub power source ELVDD_2. However, the present invention is not limited thereto, and the first power source ELVDD may include three or more sub power sources. The first sub power source ELVDD_1 and the second sub power source ELVDD_2 may be respectively positioned on both sides of a display unit 40 which face each other.

A data driver 20 of the organic light-emitting display according to the third exemplary embodiment may include a first sub data driver 21 and a second sub data driver 22. In addition, the scan driver 10 may include a first sub scan driver 11 for transmitting scan signals to a first pixel block 41, a second sub scan driver 12 for transmitting scan signals to a second pixel block 42, and a third sub scan driver 13 for transmitting scan signals to a third pixel block 43. However, the present invention is not limited thereto. The data driver 20 may include three or more sub data drivers, and the scan driver 10 may include two, four, or more sub scan drivers.

Referring to FIGS. 6 and 7, the scan driver 10 includes first though n^{th} stages 421 through 42n coupled to scan lines 51 through Sn, respectively. A timing controller 60 transmits two clock signals CLK1 and CLK1_B and three start signals SP1 through SP3 to the scan driver 10. The first start signal SP1 is transmitted to the first stage 421 which is a first stage of the first sub scan driver 11, the second start signal SP2 is transmitted to the (i+1)^{th} stage 421+1 which is a first stage of the second sub scan driver 12, and the third start signal SP3 is transmitted to the (j+1)^{th} stage 42j+1 which is a first stage of the third sub scan driver 13. That is, the first through third sub scan drivers 11 through 13 may be driven individually by the first through third start signals SP1 through SP3, respectively.

Referring to FIG. 8, the emission driver 30 according to the third exemplary embodiment includes first through n^{th} stages 321 through 32n coupled to light emission control lines E1 through En, respectively. The timing controller 60 transmits the two clock signals CLK and CLK_B, three start signals SP4 through SP6 and three block control signals Block_1 through Block_3 to the emission driver 30. The fourth start signal SP4 is transmitted to the first stage 321 which is a first stage of a first sub emission driver 31, the fifth start signal SP5 is transmitted to the (i+1)^{th} stage 32i+1 which is a first stage of a second sub emission driver 32, and the sixth start signal SP6 is transmitted to the (j+1)^{th} stage 32j+1 which is a first stage of a third sub emission driver 33. The first block control signal Block_1 is transmitted to the first sub emission driver 31, the second block control signal Block_2 is transmitted to the second sub emission driver 32, and the third block control signal Block_3 is transmitted to the third sub emission driver 33. That is, the first through third sub emission drivers 31 through 33 may be driven individually by the fourth through sixth start signals SP4 through SP6, respectively.

A method of driving the organic light-emitting display according to the third exemplary embodiment will now be described. First, it is determined whether to drive the organic light-emitting display according to the third exemplary embodiment using a conventional driving method or a pixel block-based driving method. To this end, data for each of the first through third pixel blocks 41 through 43 are added together, and a value of the added data for each of the first through third pixel blocks 41 through 43 is compared with a reference value. When all of values of the added data for the first through third pixel blocks 41 through 43 are equal to or less than the reference value, the organic light-emitting display is driven using a conventional driving method instead of a pixel block-based driving method. On the other hand, when any one of the values of the added data for the first through third pixel blocks 41 through 43 exceeds the reference value, the organic light-emitting display is driven using a pixel block-based driving method according to the third exemplary embodiment of the present invention, as will be described below.

A method of driving the organic light-emitting display of FIG. 6 using a pixel block-based driving method will now be described with reference to FIGS. 6 through 9.

The first start signal SP1 and the third start signal SP3 are concurrently (e.g., simultaneously) and respectively transmitted to the first stage 421 which is the first stage of the first sub scan driver 11 and the (j+1)^{th} stage 42j+1 which is the first stage of the third sub scan driver 13. Then, the pixels 50 of the first pixel block 41 coupled to the scan lines S1 through Si of the first sub scan driver 11 and the pixels 50 of the third pixel block 43 coupled to the scan lines Sj+1 through Sn of the third sub scan driver 13 are selected concurrently (e.g., simultaneously) and sequentially.

The fourth start signal SP4 and the sixth start signal SP6 (e.g., a low level signal) are concurrently (e.g., simultaneously) and respectively transmitted to the first stage 321 of the first sub emission driver 31 and the (j+1)^{th} stage 32j+1 of the third sub emission driver 33. Also, the clock signals CLK and CLK_B are transmitted to the first sub emission driver 31 and the third sub emission driver 33. The first sub emission driver 31 applies a voltage of a fourth power source VSS to the light emission control lines E1 through Ei during a period of time after data signals are transmitted respectively to the pixels 50 of the first pixel block 41 and before the pixels 50 of the second pixel block 42 are driven. At the same time, the third sub emission driver 33 applies the voltage of the fourth power source VSS to the light emission control lines Ej+1 through En during a period of time after data signals are transmitted respectively to the pixels 50 of the third pixel block 43 and before the pixels 50 of the second pixel block 42 are driven. That is, after the data signals are transmitted respectively to the pixels 50 of the first and third pixel blocks 41 and 43, the pixels 50 of the first and third pixel blocks 41 and 43 emit light until the pixels 50 of the second pixel block 42 are driven.

During a period of time after all of the pixels 50 of the first and third pixel blocks 41 and 43 are concurrently (e.g., simultaneously) driven to emit light and before the pixels 50 of the second pixel block 42 emit light, the first block control signal Block_1 set to a low level is transmitted to a tenth transistor M10 of each of the first through i^{th} stages 321 through 32i of the first sub emission driver 31 while the third block control signal Block_3 set to a low level is transmitted to the tenth transistor M10 of each of the (j+1)^{th} through n^{th} stages 32j+1 through 32n of the third sub emission driver 33. As a result, the tenth transistor M10 is turned on. When the tenth transistor M10 is turned on, a voltage of a third power source VDD is applied to the light emission control lines E1 through Ei and Ej+1 through En. That is, after the pixels 50 of the first and third pixel blocks 41 and 43 are concurrently (e.g., simultaneously) driven to emit light, if the pixels 50 of the second pixel block 42 are driven to emit light, the pixels 50 of the first and third pixel blocks 41 and 43 are concurrently (e.g., simultaneously) made to not emit light. The voltage of the third power source VDD is applied to the light emission control lines E1 through Ei and Ej+1 through En of the first and third sub emission drivers 31 and 33 until the fourth and sixth start signals SP4 and SP6 are transmitted again to the first and third sub emission driver 31 and 33.

After all of the pixels 50 of the first and third pixel blocks 41 and 43 are sequentially driven to emit light, the fifth start signal SP5 (e.g., a low level signal) is transmitted to the (i+1)^{th} stage 32i+1 of the second sub emission driver 32. Also, the clock signals CLK and CLK_B are transmitted to the second sub emission driver 32. The second sub emission driver 32 applies the voltage of the fourth power source VSS to the light emission control lines Ei+1 through Ej during a period of time after data signals are transmitted respectively to the pixels 50 of the second pixel block 42 and before the fourth and sixth start signals SP4 and SP6 are transmitted again to the first and third sub emission drivers 31 and 33. That is, after the data signals are transmitted respectively to the pixels 50 of the second pixel block 42, the pixels 50 of the second pixel block 42 emit light until the pixels 50 of the first and third pixel blocks 41 and 43 are driven.

During a period of time after all of the pixels 50 of the second pixel block 42 are driven to emit light and before the fourth and sixth start signals SP4 and SP6 are transmitted again to the first and (j+1)^{th} stages 321 and 32j+1 of the first and third sub emission drivers 31 and 33 so that the pixels 50 of the first and third pixel blocks 41 and 43 emit light again, the second block control signal Block_2 set to a low level is transmitted to the tenth transistor M10 of each of the (i+1)^{th} through j^{th} stages 32i₊1 through 32j of the second sub emission driver 33, thereby turning the tenth transistor M10 on. When the tenth transistor M10 is turned on, the voltage of the third power source VDD is applied to the light emission control lines Ei+1 through Ej. That is, when the pixels 50 of the first and third pixel blocks 41 and 43 are driven to emit light by the fourth and sixth start signals SP4 and SP6 transmitted again to the first and (j+1)^{th} stages 321 and 32j+1 of the first and third sub emission drivers 31 and 33, the pixels 50 of the second pixel block 42 do not emit light.

In the organic light-emitting display and the method of driving the same according to the third exemplary embodiment, since the first and third pixel blocks 41 and 43 are concurrently (e.g., simultaneously) driven, the data driver 20 includes the first and second sub data drivers 21 and 22.

In the organic light-emitting display and the method of driving the same according to the third exemplary embodiment, the pixels 50 are driven on a pixel block-by-pixel block basis during one frame. That is, when the pixels 50 of the first and third pixel blocks 41 and 43 are concurrently (e.g., simultaneously) driven to emit light, the pixels 50 of the second pixel block 42 are not driven and thus do not emit light. When the pixels 50 of the second pixel block 42 are driven to emit light, the pixels 50 of the first and third pixel blocks 41 and 43 are not driven and thus do not emit light. As a result, the amount of current flowing through the pixels 50 concurrently (e.g., simultaneously) is limited, thereby reducing or minimizing the IR drop. The reduction or minimization of the IR drop can prevent the deterioration of display quality.

An organic light-emitting display and a method of driving the same according to a fourth exemplary embodiment of the present invention will be described with reference to FIGS. 3, 10, and 11.

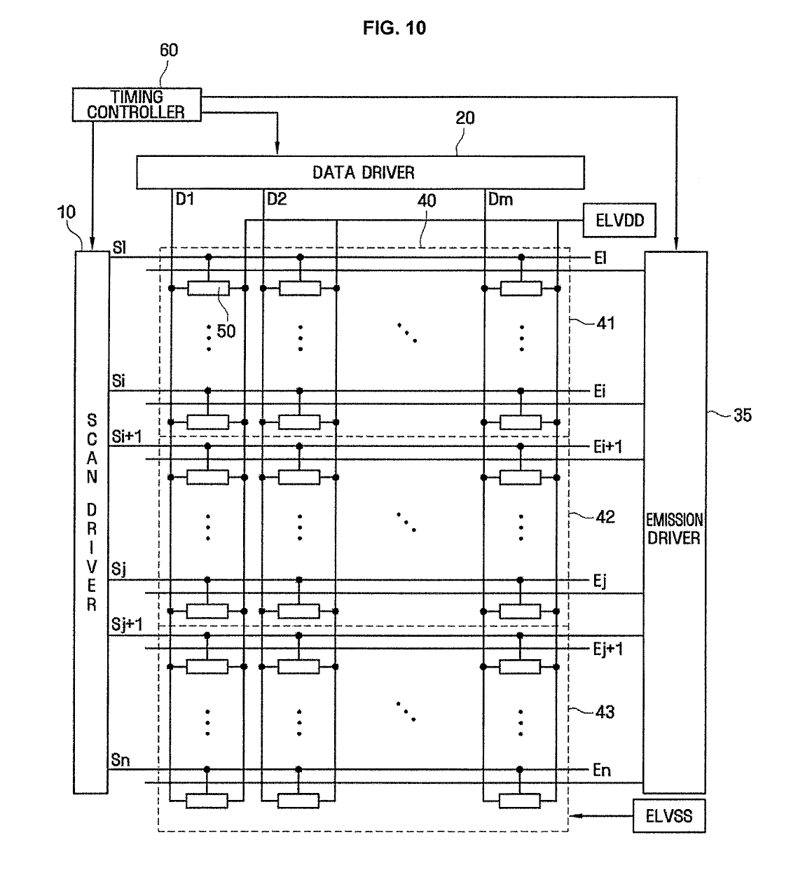

FIG. 10 is a block diagram of an organic light-emitting display according to a fourth exemplary embodiment of the present invention.

Referring to FIG. 10, a display unit 40 of the organic light-emitting display according to the fourth exemplary embodiment includes a plurality of pixel blocks, e.g., first through third pixel blocks 41 through 43.

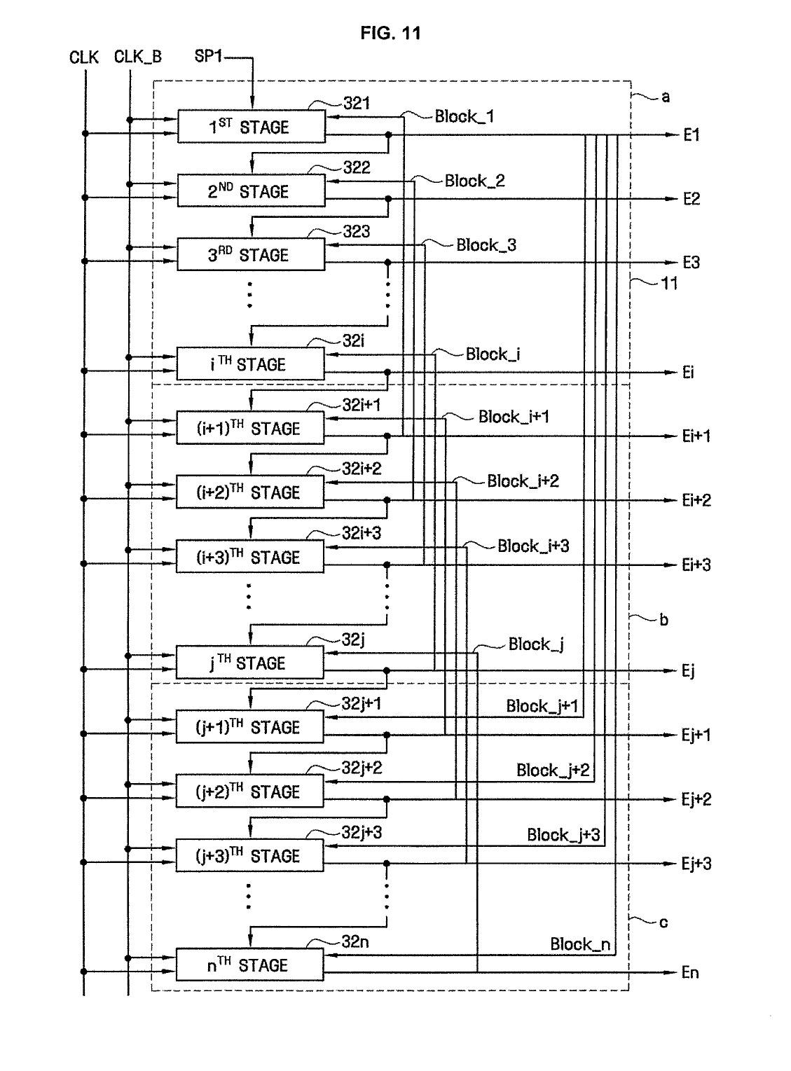

FIG. 11 is a schematic diagram of an emission driver 35 of FIG. 10 according to the fourth exemplary embodiment of the present invention. An internal circuit of each stage illustrated in FIG. 11 is substantially identical to the internal circuit illustrated in FIG. 3.

Referring to FIG. 11, the emission driver 35 according to the fourth exemplary embodiment includes first through n^{th} stages 321 through 32n coupled to light emission control lines E1 through En, respectively. The first through n^{th} stages 321 through 32n may be divided into a first part a which is coupled to pixels 50 of the first pixel block 41, a second part b which is coupled to pixels 50 of the second pixel block 42, and a third part c which is coupled to pixels 50 of the third pixel block 43.

A timing controller 60 (see FIG. 1) transmits two clock signals CLK and CLK_B and a start signal SP1 to the emission driver 35. The start signal SP1 is transmitted to the first stage 321. An output of the i^{th} stage 32i (where i is a natural number) is transmitted to the (i+1)^{th} stage 321+1.

In the fourth exemplary embodiment of the present invention, a block control signal transmitted to each stage is not supplied from an external source. Instead, an output signal of another stage is used as the block control signal. For example, a block control signal Block_1 transmitted to the first stage 321, which is a first stage of the first part a coupled to the first pixel block 41, is a signal output from the light emission control line Ei+1 of the (i+1)^{th} stage 32i+1 which is a first stage of the second part b coupled to the second pixel block 42. In addition, a block control signal Block_2 transmitted to the second stage 322, which is a second stage of the first part a coupled to the first pixel block 41, is a signal output from the light emission control line Ei+2 of the (i+2)^{th} stage 32i+2 which is a second stage of the second part b coupled to the second pixel block 42.

A method of driving the organic light-emitting display according to the fourth exemplary embodiment will now be described. As described above with reference to FIG. 4, data for each of the first through third pixel blocks 41 through 43 are added together, and a value of the added data for each of the first through third pixel blocks 41 through 43 is compared with a reference value. When all of the values of the added data for the first through third pixel blocks 41 through 43 are equal to or less than the reference value, the organic light-emitting display is driven using a conventional driving method instead of a pixel block-based driving method. On the other hand, when any one of the values of the added data for the first through third pixel blocks 41 through 43 exceeds the reference value, the organic light-emitting display is driven using a sliding driving method according to the fourth exemplary embodiment of the present invention, as will be described below.

Referring to FIGS. 3, 10, and 11, when the start signal SP1 and the clock signals CLK and CLK_B are transmitted to the first stage 321 of the emission driver 35, a voltage of a fourth power source VSS is applied to the light emission control lines E1 through Ei during a period of time after data signals are transmitted respectively to the pixels 50 of the first pixel block 41 and before the pixels 50 of the second pixel block 42 are driven. That is, after the data signals are transmitted respectively to the pixels 50 of the first pixel block 41, the pixels 50 of the first pixel block 41 emit light until the pixels 50 of the second pixel block 42 are driven.

An output of the i^{th} stage 32i, which is a last stage of the first part a coupled to the first pixel block 41, is transmitted to the (i+1)^{th} stage 32i+1 which is the first stage of the second part b coupled to the second pixel block 42. When the voltage of the fourth power source VSS is applied to the light emission control line Ei+1 after data signals are transmitted respectively to the pixels 50 coupled to the (i+1)^{th} stage 32i+1, it is also applied to the first stage 321, which is the first stage of the first part a coupled to the first pixel block 41, as the block control signal Block_1 of the first stage 321. As a result, the pixels 50 coupled to the (i+1)^{th} stage 32i+1, which is the first stage of the second part b coupled to the second pixel block 42, emit light while the pixels 50 coupled to the first stage 321, which is the first stage of the first part a coupled to the first pixel block 41, do not emit light as a tenth transistor M10 is turned on.

That is, after all of the pixels 50 of the first pixel block 41 emit light, the pixels 50 coupled to the light emission control line E1 of the first stage 321, which is the first stage of the first part a coupled to the first pixel block 41, stop to emit light at the same time when the pixels 50 coupled to the light emission control line Ei+1 of the (i+1)^{th} stage 32i+1, which is the first stage of the second part b coupled to the second pixel block 42, start to emit light. Then, when the voltage of the fourth power source VSS is applied to the light emission control line Ei+2 of the (i+2)^{th} stage 32i+2 which is the second stage of the second part b coupled to the second pixel block 42, the voltage of the fourth power source VSS is also applied to the second stage 322, which is the second stage of the first part a coupled to the first pixel block 41, as the block control signal Block_2 of the second stage 322. As a result, the pixels 50 coupled to the (i+2)^{th} stage 32i+2, which is the second stage of the second part b coupled to the second pixel block 42, emit light while the pixels 50 coupled to the light emission control line E2 of the second stage 322 of the first part a that is coupled to the first pixel block 41 do not emit light. The above process is repeated sequentially.

Block control signals Block_j+1 through Block_n, which are transmitted to the (j+1)^{th} through n^{th} stages 32j+1 through 32n of the third part c coupled to the third pixel block 43, are signals output from the light emission control line E1 of the first stage 321 which is the first stage of the first part a coupled to the first pixel block 41. That is, when the pixels 50 coupled to the light emission control line E1 of the first stage 321 of the first part a coupled to the first pixel block 41 start to emit light as a next frame begins, all of the pixels 50 of the third pixel block 43 stop to emit light.

In the organic light-emitting display and the method of driving the same according to the fourth exemplary embodiment, the pixels 50 are driven on a light emission control line-by-light emission control line basis during one frame. That is, when the pixels 50 coupled to some of the light emission control lines E1 through En emit light, the pixels 50 coupled to the other ones of the light emission control lines E1 through En are not driven, and thus do not emit light. As a result, the amount of current flowing through the pixels 50 concurrently (e.g., simultaneously) is limited, thereby reducing or minimizing the IR drop. The reduction or minimization of the IR drop can prevent the deterioration of display quality.

While the present invention has been particularly shown and described with reference to exemplary embodiments thereof, it will be understood by those of ordinary skill in the art that various changes in form and details may be made therein without departing from the spirit and scope of the present invention as defined by the following claims, and equivalents thereof.

What is claimed is:

1. An organic light-emitting display comprising:
a scan driver for transmitting scan signals to scan lines;
a data driver for transmitting data signals to data lines;
an emission driver for transmitting light emission control signals to light emission control lines; and
a display unit comprising a plurality of pixels coupled to the scan lines, the data lines, and the light emission control lines,
wherein the emission driver comprises a plurality of stages, and each of the stages comprises a transistor having a first electrode coupled to a first power source, a second electrode coupled to one of the light emission control lines, and a gate electrode coupled to an input terminal to which a block control signal is input.

2. The display of claim 1, wherein the emission driver comprises a plurality of sub emission drivers, and the plurality of pixels are grouped into a plurality of pixel blocks which correspond respectively to the sub emission drivers and are driven separately by the sub emission drivers.

3. The display of claim 2, wherein the block control signal is individually transmitted to each of the sub emission drivers.

4. The display of claim 1, wherein the first power source is configured to supply a current, which corresponds to a data signal, to an organic light-emitting diode of each of the pixels, wherein the first power source comprises a plurality of sub power sources.

5. The display of claim 4, wherein each of the pixel blocks is configured to be supplied with power from a corresponding one of the sub power sources adjacent thereto.

6. The display of claim 4, wherein the scan driver comprises a plurality of sub scan drivers, wherein each of the sub scan drivers is configured to receive a start signal individually.

7. The display of claim 6, wherein the emission driver comprises a plurality of sub emission drivers, wherein each of the sub emission drivers is configured to receive the start signal and the block control signal individually.

8. The display of claim 7, wherein at least two of the sub scan drivers are configured to receive the start signal concurrently.

9. The display of claim 8, wherein at least two of the sub emission drivers are configured to receive the block control signal concurrently.

10. The display of claim 8, wherein the data driver comprises a plurality of sub data drivers equal in number to the number of the sub scan drivers.

11. The display of claim 1, wherein the display unit comprises first and second pixel blocks arranged sequentially, and the stages of the emission driver are divided into a first part coupled to the first pixel block and a second part coupled to the second pixel block, wherein an n-th stage of the second part is configured to output a signal to a corresponding one of the light emission control lines, the signal being the block control signal transmitted to an i-th stage of the first part.

12. A method of driving an organic light-emitting display, the method comprising:
transmitting a light emission control signal to a display unit from an emission driver which comprises a plurality of stages coupled respectively to a plurality of light emission control lines,
wherein when a voltage of a first power source is output from some of the light emission control lines, a block control signal is transmitted to corresponding ones of the stages coupled to the other ones of the light emission control lines so as to output a voltage of a second power source from the other ones of the light emission control lines.

13. The method of claim 12, wherein the display unit comprises first and second pixel blocks arranged sequentially, and wherein when any one of the first and second pixel blocks emits light, the other one of the first and second pixel blocks does not emit light.

14. The method of claim 13, wherein the emission driver comprises first and second sub emission drivers coupled to the first and second pixel blocks, respectively, and wherein a start signal is transmitted to a first stage of the first sub emission driver, and the block control signal is transmitted to the first sub emission driver during a period of time after the entire first pixel block emits light and before the second pixel block emits light.

15. The method of claim 12, wherein the display unit comprises first, second, and third pixel blocks arranged sequentially, and wherein the first and third pixel blocks concurrently emit light, and when the first and third pixel blocks concurrently emit light, the second pixel block does not emit light.

16. The method of claim 15, wherein the emission driver comprises first, second, and third sub emission drivers coupled to the first, second and third pixel blocks, respectively, and wherein the start signal is concurrently transmitted to respective first stages of the first and third sub emission drivers, and the block control signal is concurrently transmitted to the first and third sub emission drivers during a period of time after all of the first and third pixel blocks emit light and before the second pixel block emits light.

17. The method of claim 16, further comprising a scan driver for driving scan lines, wherein the scan driver comprises first, second and third sub scan drivers coupled to the first, second and, third pixel blocks, respectively, and wherein the start signal is concurrently transmitted to respective first stages of the first, second, and third sub scan drivers.

18. The method of claim 17, further comprising a power source for supplying a current, which corresponds to a data signal, to each pixel, wherein the power source comprises a first sub power source and a second sub power source, and wherein the first sub power source supplies power to the first pixel block, and the second sub power source supplies power to the third pixel block.

19. The method of claim 12, wherein the display unit comprises first and second pixel blocks arranged sequentially, and wherein when pixels coupled to an i-th light emission control line of the second pixel block start to emit light after the entire first pixel block emits light, pixels coupled to an i-th light emission control line of the first pixel block stop to emit light.

20. The method of claim 19, wherein the stages of the emission driver are divided into a first part coupled to the first pixel block and a second part coupled to the second pixel block, wherein a signal output from a light emission control line of an i-th stage of the second part is the block control signal transmitted to an i-th stage of the first part.
